(19) United States
(12) Patent Application Publication
(10) Pub. No.: US 2015/0296979 A1
(43) Pub. Date: Oct. 22, 2015

(54) BANANA RETAINER

(71) Applicant: Chris Todd, Canton, OH (US)

(72) Inventor: Chris Todd, Canton, OH (US)

(21) Appl. No.: 14/689,867

(22) Filed: Apr. 17, 2015

Related U.S. Application Data
(60) Provisional application No. 61/981,278, filed on Apr. 18, 2014.

(51) Int. Cl. A47B 75/00; F16M 11/04; A47G 29/00

(52) U.S. Cl. CPC A47B 75/00; A47G 29/00; F16M 11/04

(57) ABSTRACT

A banana retainer includes a base, a support arm extending upwardly from the base towards a hook configured to support a hand of bananas thereon. The retainer further includes a first retainer assembly coupled to the support arm between the base and the hook. The retainer may further include a second retainer assembly proximate the first retainer assembly. Each of the first and second retainer assembly is configured to retain a single banana therein at an upright or generally vertical position. The single banana in each retainer assembly is stored in an upright position simulates a natural storage position encouraging even ripening of the banana.

### CROSS REFERENCE TO RELATED APPLICATION

This application claims the benefit of U.S. Provisional Patent Application Ser. No. 61/981,278, filed Apr. 18, 2014; the disclosure of which is incorporated herein by reference.

### BACKGROUND OF THE INVENTION

1. Technical Field

The present invention relates generally to the field of food storage devices. More particularly, the present invention relates to a device for retaining one or more bananas. Specifically, the present invention relates to a device including a retaining assembly for retaining a single banana in an upright manner to promote even ripening.

2. Background Information

Many people throughout the world enjoy bananas as a healthy food source. Bananas are edible fruits that grow on a banana plant. On the banana plant, bananas grow in a large cluster or bunch attached to a banana heart. The banana bunch comprises anywhere from three to twenty tiers of bananas. When these tiers are separated from the bunch they are known as banana hands. The banana hands are sold throughout the world's produce markets.

Typically, bananas are harvested prior to ripening. This allows the banana hand to ripen once detached from the bunch on its way to market. Often, banana hands, as well as entire bunches, are sold to produce markets before they are fully ripened. This allows the purchased banana hand to ripen in the consumer's home.

Once a consumer has purchased a banana hand, they typically bring the bananas home and keep them in their kitchen. If the bananas are ripe, they are typically eaten right away. However, for unripe bananas, there are some devices that assist in storing and attempting to allow the banana to ripen in the consumer's home.

One such device is a banana hanger. A banana hanger is a device that includes a base and an upwardly extending support arm terminating in a hook. The hook allows a consumer to hang the banana hand in a manner that simulates the bananas hanging in a bunch on a banana plant. It is believed that this position encourages even ripening.

However, a problem continues to exist with these known banana hangers. Bananas are consumed one at a time, and as such, eventually there will be one banana left. A single banana cannot hang from the hook on the banana hanger. Ordinarily, a consumer will place the banana in a horizontal position laying on the kitchen countertop. The horizontal alignment of the last remaining banana is bad for the ripening process. The pressure exerted on the banana skin while lying flat causes uneven ripening, which can lead to one side of the banana rotting.

### SUMMARY

Thus, a need continues to exist in addressing the issue of how to properly store a single remaining banana from a banana hand once the other bananas are consumed. The present invention addresses this and other issues.

In one aspect, the invention may provide a banana retaining device comprising: a base; a support arm coupled to the base and extending upward therefrom; a first retaining assembly coupled to the support arm at a position between the two ends of the support arm.

In another aspect, the invention may provide a banana retaining device comprising: a base including a left edge and a right edge when viewed from the front; a first plane aligned with the left edge; a second plane aligned with the right edge; and a retaining assembly positioned between the first and second plane.

In another aspect, one embodiment may provide a method for storing a banana on a retaining device comprising the steps of: providing a fruit retaining assembly including a support member; inserting a fruit through a portion of the support member; and engaging the fruit with the support member to support the fruit in a generally vertical position.

In another aspect, an embodiment may provide a banana retaining device comprising: a base; a support arm coupled to the base and extending upward therefrom; a first retaining assembly coupled to the support arm at a vertical position between the two ends of the support arm. This embodiment may further include a second retaining assembly coupled to the support arm at a vertical position between the two ends of the support arm. Further, this embodiment may provide wherein the first and second retaining assemblies are at the same vertical height. And, this embodiment may provide, wherein the first and second retaining assemblies are disposed on opposite sides of the support arm. Also, an instance may provide, wherein the first retaining assembly includes an upper support member and a lower support member; and the upper support member extending in a cantilevered manner from a rigid connection with the support arm. This embodiment may include a middle portion of the upwardly extending support arm; and wherein the upper support member of the first retaining assembly is closely adjacent the middle portion. Even further, the upper support member may be an annular ring defining an aperture therethrough, the annular having a diameter of about two inches. Additionally, wherein the first retaining assembly further includes a lower support member spaced below the upper support member; wherein the lower support member is an annular ring defining an aperture therethrough, the annular ring having a diameter of about one inch. Yet further, the embodiment may provide wherein the first retaining assembly further includes a lower support member spaced below the upper support member; and wherein the lower support member extends in a cantilevered manner from a rigid connection with the support arm.

Another aspect of an embodiment may provide a banana retaining device comprising: a base including a left edge and a right edge when viewed from the front; a first vertical plane aligned with the left edge; a second vertical plane aligned with the right edge; a support arm coupled to the base and extending upward therefrom between the first and second vertical planes; and a first retaining assembly positioned between the first and second plane adapted to retain a fruit in a generally vertical position. This embodiment may also include a second retaining assembly positioned between the first and second plane adapted to retain a fruit in a generally vertical position. Additionally, the embodiment may include wherein both the first and second retaining assemblies are connected to the support arm in a cantilevered manner and extend outwardly therefrom in opposite directions. Even further, wherein a width measured from an outer edge of the first retaining assembly to an outer edge of the second retaining assembly is wholly positioned between the first plane and the second plane.

An embodiment may provide a method for storing a banana on a retaining device comprising the steps of: providing a fruit retainer including a support member; engaging a fruit with a portion of the support member; and supporting the fruit in a generally vertical position. This method may further include wherein the support member through which the fruit is engage is an annular ring cantilevered connected to a vertically extending support arm, further comprising the steps of: inserting an end of the fruit through the annular ring; and lowering the end of the fruit to a vertical height below the ring while simultaneously ensuring a portion of the fruit remains within an aperture defined by the annular ring.

In another aspect, the invention may provide a banana retainer including a base, a support arm extending upwardly from the base towards a hook configured to support a hand of bananas thereon. The retainer further including a first retainer assembly coupled to the support arm between the base and the hook. The retainer may further include a second retainer assembly proximate the first retainer assembly. Each of the first and second retainer assembly is configured to retain a single banana therein at an upright position. The single banana in an upright position provides a natural storage position encouraging even ripening of the banana.

### BRIEF DESCRIPTION OF THE SEVERAL VIEWS OF THE DRAWINGS

A sample embodiment of the invention, is set forth in the following description, is shown in the drawings and is particularly and distinctly pointed out and set forth in the appended claims. The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is right side perspective view of a banana retaining device of the present invention;

FIG. 2 is top perspective view of the present invention; and

FIG. 3 is front elevation view of the present invention.

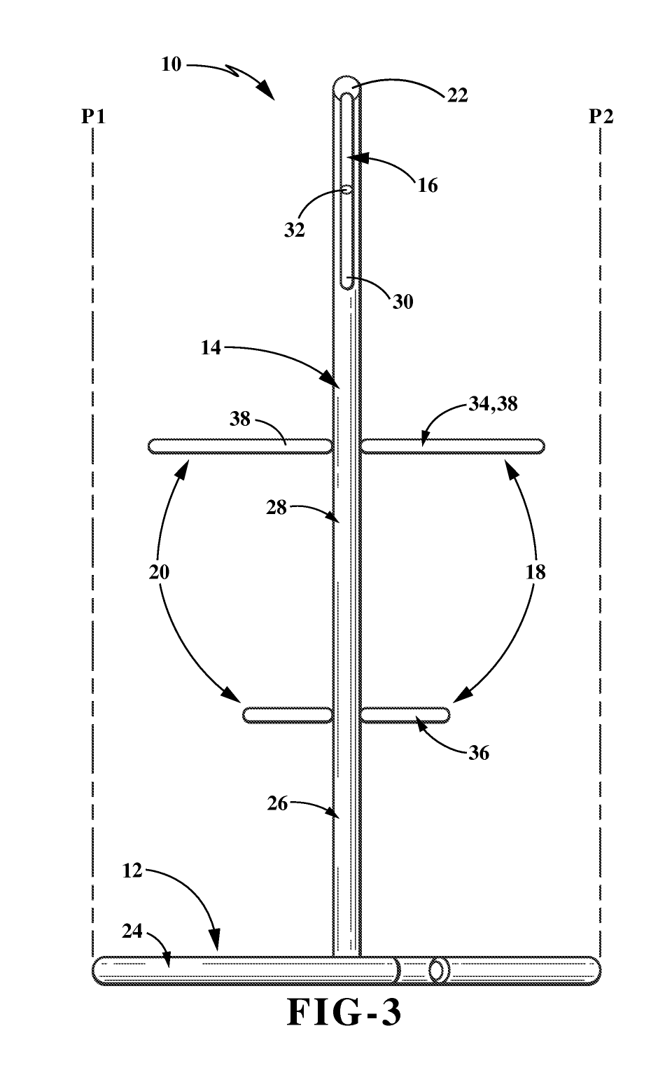

Similar numbers refer to similar parts throughout the drawings.

### DETAILED DESCRIPTION

The elongated fruit or banana retainer that is the subject of the present invention is shown generally as 10. Banana retainer 10 permits one or two bananas to be retained in a generally vertical or upright position rather than placing them horizontally on a surface that leads to uneven ripening.

Retainer 10 broadly includes a base 12, a support arm 14 extending upwardly from base 12, a support hook 16 coupled to support arm 14 adjacent a free end 22, a first retaining assembly 18, and a second retaining assembly 20 adjacent the first retaining member 18.

In a preferred embodiment base 12 includes an annular support ring 24. Support ring 24 is preferably circular having a diameter D1. Support ring 24 is preferably formed from a bent cylindrical member such that ring 24 is circular in cross section. Base 12 includes a downwardly facing bottom surface and an upwardly facing top surface. In the shown embodiment, bottom surface of base 12 is convex when viewed in cross section. Similarly, top surface of base 12 is convex when viewed in cross section. Preferably when retainer 10 is positioned atop a conventional countertop in a kitchen, a bottom surface of base 12 contacts the countertop. In an alternative embodiment, base 12 may be solid or configured from another geometric shape.

With continued reference to annular base 12, two diametrically opposed imaginary planes P1, P2 extend vertically upward at each outer edge of ring 24 on base 12. When viewed in a front elevation view, the first plate P1 extends upward from the far left edge of ring 24 and second plane P2 extends upward from the far right edge of ring 24. In this view, support arm 14 is positioned between first plane P1 and second plane P2.

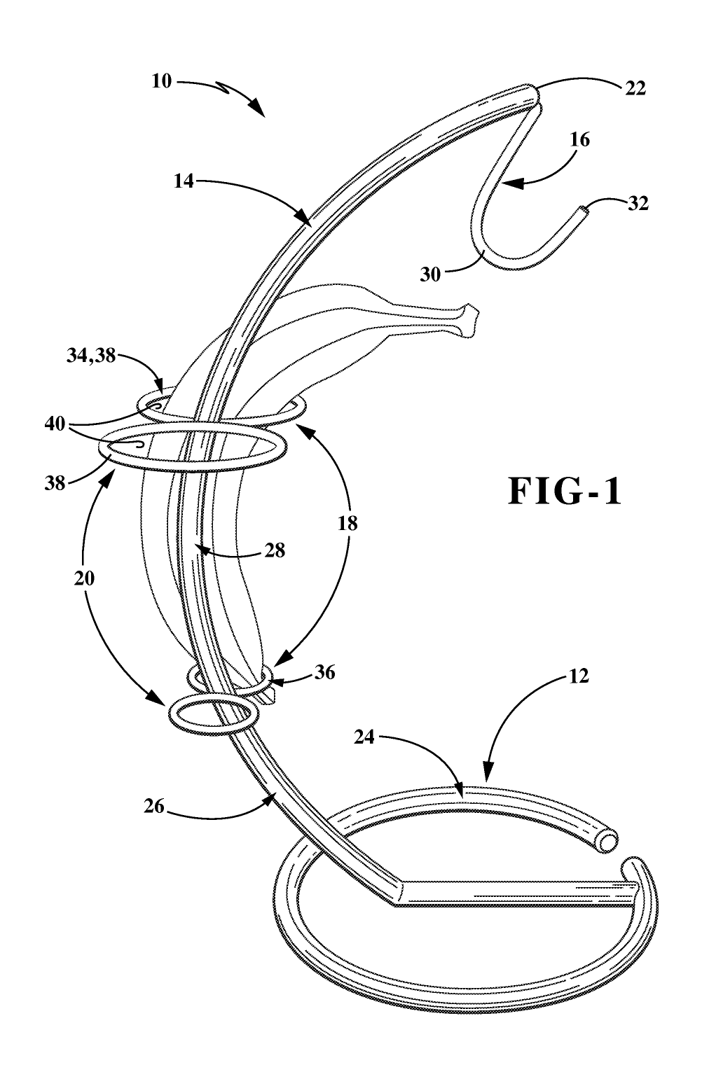

Support arm 14 includes a bottom end 26 secured to base 12, and middle portion 28, and the upper free end 22. Preferably, bottom end 26 is secured to ring 24, however other locations securing bottom 26 to base 12 are contemplated. Support arm is preferably formed from a bent solid cylindrical material such that arm 14 includes a circular cross section. However, clearly it is to be understood that alternative geometric configurations are entirely possible. Further, while support arm 14 is preferably composed of a metal material, non-conductive materials, such as wood, or additional synthetics, are entirely possible. When viewed from the side, as in FIG. 1, support arm 14 extends arcuately upward from adjacent base 12 in towards free end 22.

With continued reference to the right side perspective view of FIG. 1, middle portion 28 is positioned at a vertical higher than base 12 and outside the imaginary vertical column of base 12. Support arm 14 curves inward such that free end 22 is disposed at a vertical height above base 12 and approximately directly above the center of base 12.

Fruit support hook 16 extends downward from free end 22 towards center of base 12. In the shown embodiment, hook 16 includes a first segment extending downwardly from free end 22 connected to an upwardly extending arcuate segment 30. Arcuate segment 30 extends to an upwardly facing hook end 32. Upwardly turned hook end 32 permits an object, preferably a hand of bananas, to hang from hook 16 vertically above base 12 preferably adjacent the approximate center.

As will be described in detail below, first retaining assembly 18 is mirroredly configured as second retaining assembly 20. For the purposes of brevity, components described below present in first retaining 18 are also present in second retaining assembly 20 in a similar configuration positions opposite an imaginary vertical line of symmetry extending through the center of support arm 14 centered between plane P1 and plane P2.

First retaining assembly 18 includes an upper support member 34 spaced apart and positioned above a lower support member 36. Upper support member 34 is coupled to support arm 14 adjacent middle portion 28. The coupling of support member 34 to support arm 14 is a rigid connection, such that upper support member 34 extends outwardly from support arm 14 in a cantilevered manner. In one embodiment where both support arm 14 and upper support member 34 are fabricated from metal, a welded union may join support arm 14 and upper support member 34 together.

Support member 34 is configured to support and retain an elongated fruit therethrough, namely a banana, in an upright manner or a generally vertical and upright position. In the shown embodiment, upper support member 34 is an annular member 38 defining an aperture 40 therein. Aperture 40 preferably has a diameter slightly greater than the outer diameter of an average banana; specifically aperture is approximately 2 inches in diameter. Annular member 38 is preferably constructed of a bent cylindrical form of metal such that member 38 is circular in cross section; however other geometric configurations are clearly contemplated.

While support member 34 is described above by way of the non-limiting exemplary as an annular ring 38, alternative embodiments of a support member 34 for the present invention 10 are clearly contemplated. One exemplary non-limiting alternative embodiment can be an adjustable clip configured to expendably grasp an elongated fruit at a variety of diameters, such as plantains, which are diametrically larger than bananas. Further, while member 34 is shown as fixedly attached to support arm 14, alternative embodiments permit support member 34 to adjust along the length of support arm 14 to compensate for different length fruits.

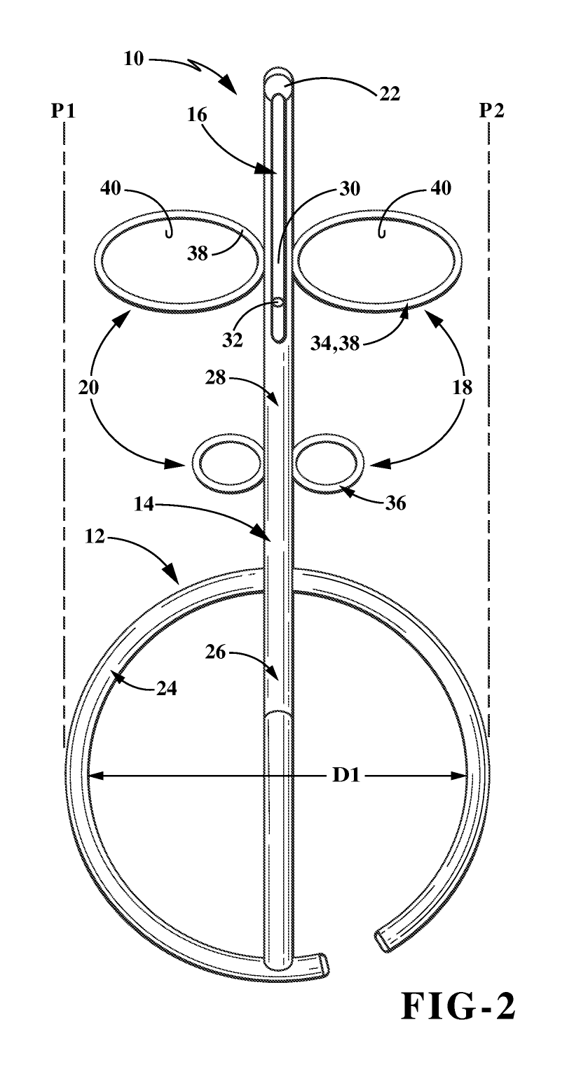

For a stable retainer 10 when supporting a banana within retaining assembly 18 or 20, upper support member 34 must be positioned between first plate P1 and second plane P2 when viewed in elevation from the front (See FIG. 2). With continued reference to FIG. 2, a width measured from outer edge of first retaining assembly 18 to a spaced apart outer edge of second retaining assembly 20 is wholly positioned between first plane P1 and second plane P2.

The configuration ensures the balance of device 10 such that it will not tip over when supporting one or two bananas within the retaining assembly 18 or 20.

Lower support member 36 is coupled to support arm 14 beneath middle portion 28 and above base end 26. The coupling of lower support member 36 to support arm 14 is a rigid connection, such that lower support member 36 extends outwardly from support arm 14 in a cantilevered manner. In one embodiment where both support arm 14 and upper support member 34 are fabricated from metal, a welded union may join support arm 14 and lower support member 36 together. Other manners of coupling support arm 14 and lower support member 36 together are entirely possible, such as mechanical fastening, chemical fastening, or non-mechanical and non-chemical fastening.

Similar to the upper support member, the lower support member 36 is positioned between first plate P1 and second plane P2 when viewed in elevation from the front (See FIG. 2). Support member 36 is disposed beneath upper support member 34. Lower support member 36 is preferably an annular construction similar to upper member 34, but rather having a smaller diameter. Diameter of lower support member 36 is approximately 1 inch. The smaller diameter of lower member 36 is designed to support a banana tail thereon. Further, while lower member 36 is contemplated as being annular in shape, it is to be clearly understood that other geometrical configurations, including but not limited to, a U-shaped member, a small plate, or others, are entirely possible.

Additionally, while lower support member 36 is described above and depicted throughout the figures, by way of the non-limiting example, as an annular ring, alternative embodiments of a lower support member 36 for the present invention 10 are clearly contemplated. One exemplary non-limiting alternative embodiment can be an adjustable clip configured to expendably grasp a banana. Further, while lower support member 36 is shown as fixedly coupled to support arm 14, alternative embodiments permit lower support member 36 to adjust along the length of support arm 14 to compensate for different length fruits.

In accordance with one aspect of the present invention device 10 keeps the last one or two bananas remaining from a banana hand in an upright position. The upright position of the banana is supported by retaining assembly 18 or 20 on device 10. The upright position encourages even ripening of a banana. Thus, device 10 ensures that all bananas a consumer purchases will be evenly ripe.

In operation, a consumer will position device 10 upon a surface, ordinarily a kitchen countertop. Device 10 is positioned such that base 12 stably engages the countertop and support arm 14 extends upwardly therefrom above the countertop. The consumer will then hang a banana hand (i.e., a plurality of bananas joined at a their respective tops; preferably three bananas or more) from hook 16 by the hand top as is commonly understood in the art. The consumer will then remove bananas from the hand, as desired, until one or two bananas from the hand remain.

When the last one or two bananas from the hand remain, the consumer will insert the last bananas into one of the retaining assembly(s) 18 or 20. The base or tail of the banana is vertically aligned with upper support member 34. The banana tail is then inserted through aperture 40 and moved downward towards lower support member 36. The banana moves downward until banana base engages lower support member 36 and rests thereon. The annular ring 38 of upper support member 34 engages the outer surface of the banana at a location above the banana base, and in one particular embodiment around three quarters distance of the banana length. The banana remains in this generally vertical position to evenly ripen until it is ready to be consumed.

To remove the remaining bananas from retaining assembly 18, consumer will grasp the top of banana and extract it in an upward manner. The banana base is released from its engagement with lower support member 36 and moved upwardly through aperture 40. Once free from retaining assembly 18 or 20 on device 10, banana is free to be peeled and consumed.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

What is claimed:

1. A banana retaining device comprising:
a base;
a support arm coupled to the base and extending upward therefrom;
a first retaining assembly coupled to the support arm at a vertical position between the two ends of the support arm.

2. The banana retaining device of claim 1, further comprising:
a second retaining assembly coupled to the support arm at a vertical position between the two ends of the support arm.

3. The banana retaining device of claim 2, wherein the first and second retaining assemblies are at the same vertical height.

4. The banana retaining device of claim 2, wherein the first and second retaining assemblies are disposed on opposite sides of the support arm.

5. The banana retaining device of claim 1, wherein the first retaining assembly includes an upper support member and a lower support member; and
the upper support member extending in a cantilevered manner from a rigid connection with the support arm.

6. The banana retaining device of claim 5, further comprising:
a middle portion of the upwardly extending support arm; and
wherein the upper support member of the first retaining assembly is closely adjacent the middle portion.

7. The banana retaining device of claim 5, wherein the upper support member is an annular ring defining an aperture therethrough, the annular having a diameter of about two inches.

8. The banana retaining device of claim 5, wherein the first retaining assembly further includes a lower support member spaced below the upper support member;
wherein the lower support member is an annular ring defining an aperture therethrough, the annular ring having a diameter of about one inch.

9. The banana retaining device of claim 5, wherein the first retaining assembly further includes a lower support member spaced below the upper support member;
wherein the lower support member extends in a cantilevered manner from a rigid connection with the support arm.

10. A banana retaining device comprising:
a base including a left edge and a right edge when viewed from the front;
a first vertical plane aligned with the left edge;
a second vertical plane aligned with the right edge;
a support arm coupled to the base and extending upward therefrom between the first and second vertical planes; and
a first retaining assembly positioned between the first and second plane adapted to retain a fruit in a generally vertical position.

11. The banana retaining device of claim 10, further comprising:
a second retaining assembly positioned between the first and second plane adapted to retain a fruit in a generally vertical position.

12. The banana retaining device of claim 11, wherein both the first and second retaining assemblies are connected to the support arm in a cantilevered manner and extend outwardly therefrom in opposite directions.

13. The banana retaining device of claim 12, wherein a width measured from an outer edge of the first retaining assembly to an outer edge of the second retaining assembly is wholly positioned between the first plane and the second plane.

14. A method for storing a banana on a retaining device comprising the steps of:
providing a fruit retainer including a support member;
engaging a fruit with a portion of the support member; and
supporting the fruit in a generally vertical position.

15. The method of claim 14, wherein the support member through which the fruit is engaged is an annular ring connected cantilever to a vertically extending support arm, further comprising the steps of:
inserting an end of the fruit through the annular ring; and
lowering the end of the fruit to a vertical height below the ring while simultaneously ensuring a portion of the fruit remains within an aperture defined by the annular ring.
